(19) United States
(12) Patent Application Publication
(10) Pub. No.: US 2012/0246634 A1
(43) Pub. Date: Sep. 27, 2012

(54) PORTABLE VIRTUAL APPLICATIONS

(75) Inventors: Mark Wright, Austin, TX (US); Graham Perks, Round Rock, TX (US); Michael Zrubek, Granger, TX (US)

(73) Assignee: DELL PRODUCTS L.P.

(21) Appl. No.: 13/070,168

(22) Filed: Mar. 23, 2011

(51) Int. Cl. G06F 9/445

(52) U.S. Cl. 717/174

(57) ABSTRACT

In accordance with the present disclosure, a method for operating a virtual application comprises loading an image of the virtual application into a memory of an information handling system from a deployment package is disclosed. A shared library that is required for executing the virtual application is loaded. An address for a memory location corresponding to an entry point for a function in the shared library is saved to an address table for the virtual application. The virtualization data from the deployment package is used to determine whether the address for the memory location corresponding to the entry point for a function in the shared library should be adjusted.

### TECHNICAL FIELD

The present disclosure relates generally to the operation of computer systems and information handling systems, and, more particularly, to portable virtual applications.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The information handling system may include one or more operating systems. An operating system serves many functions, such as controlling access to hardware resources and controlling the execution of application software. Operating systems also provide resources and services to support application software. These resources and services may include a file system, a centralized configuration database (such as the registry found in Microsoft Windows operating systems), a directory service, a graphical user interface, a networking stack, device drivers, and device management software. In some instances, services may be provided by other application software running on the information handling system, such as a database server. An information handling system may include one more software applications.

Most applications are distributed in an executable file format, and the particular executable file format used to distribute an application depends upon the characteristics of the target information handling system, such as the processor architecture and the operating system. Common executable file formats include the Portable Executable (PE) format used by Microsoft Windows operating systems, the Mach-O format used by Apple Mac OS X operating systems, and the Executable and Linkable Format (ELF) used by some Unix and Linux operating systems.

Many applications use services provided by the operating system or those offered by other applications. Such access is usually provided through an application programming interface (API). The API defines the data types and functions that can be used by or called by an application to interact with the service. An API may be implemented as a shared library or shared object, such as a dynamic link library (DLL). For the purpose of this disclosure, the terms “shared library” and “shared object” are used interchangeably. It is advantageous to implement an API using a shared library because only a single copy of the shared library's code needs to be loaded into the information handling system's main memory, regardless of the number of applications that may access it concurrently. Each function that is implemented by the shared library has an entry point. At runtime, an application calls a function in a shared library by issuing an instruction to the central processing unit, known as a jump instruction, such that the central processing unit begins executing the code that starts at the entry point for the function. The shared library contains a data structure, usually referred to as an export table, which identifies all of the functions available in the shared library, and their corresponding entry points.

When an application needs to use the functionality provided by a shared library, the developer imports or declares the relationship using the syntax required by the particular programming language used to code the application. When the developer compiles the application's source code, the compiler generates one or more files containing object code. The object code is then passed to a linker module, which may be separate from the compiler. The linker combines the object code, and formats it according to a selected executable file format. For each shared library used by the application, the linker creates an entry in a data structure, commonly referred to as an import table. The import table identifies the shared library used by the application, and identifies all of the functions within the shared library that are called by the application. The import table is placed in the executable file as specified by the executable file format so that it can be loaded by an operating system's loader.

When an application is selected for execution on the information handling system, the application must be retrieved from a long term storage medium, such as a hard drive, and copied into the information handling system's main memory. A module of the operating system known as the loader is responsible for this task, and also prepares the execution environment necessary to run the application. The loader typically validates that the memory requirements for the application can be met, sets permissions, copies the application image into memory, copies any command line arguments onto the stack, and initializes the registers. When the loader reads the executable file, it identifies any shared libraries that the application may call using information stored in the import tables or other data structures in the executable file. For each shared library, the loader must determine whether or not the shared library is already loaded in main memory. If the shared library is not already loaded in memory, the loader will allocate memory space for the shared library, and load the image of the shared library into memory. For each function called by the application that resides in the shared library, the loader will calculate the address of each function's entry point and update the corresponding entry in the memory-resident copy of the application's import table. Once all of these tasks are complete, the loader performs a jump to the application's entry point, and the application begins executing.

### SUMMARY

In accordance with the present disclosure, a method for operating a virtual application comprises loading an image of the virtual application into a memory of an information handling system from a deployment package. A shared library that is required for executing the virtual application is loaded. An address for a memory location corresponding to an entry point for a function in the shared library is saved to an address table for the virtual application. The virtualization data from the deployment package is used to determine whether the address for the memory location corresponding to the entry point for a function in the shared library should be adjusted.

A non-transitory computer-readable storage medium with an executable file stored thereon is disclosed. The executable file causes a microprocessor to load an image of a virtual application into a memory of an information handling system from a deployment package. A shared library that is required for executing the virtual application is loaded. An address for a memory location corresponding to an entry point for a function in the shared library is saved to an address table for the virtual application. The virtualization data from the deployment package is used to determine whether the address for the memory location corresponding to the entry point for a function in the shared library should be adjusted.

A process for creating a virtual application is disclosed. An image of a virtual application is created from an application executing on an information handling system. The image of the virtual application is saved to a deployment package. A shared library required for executing the virtual application is identified. An address for a memory location corresponding to an entry point for a function in the shared library is saved to an address table in the image of the virtual application. The deployment package is formatted in an executable file format and saved to a non-transitory computer-readable storage medium.

The system and method disclosed herein is technically advantageous because it provides a way to isolate a virtual application from changes made to shared libraries required by the virtual application. The system and method provides a way to further isolate a virtual application from changes made to an underlying operating system. The system and method provides a way to port an application to different information handling systems when the source code for the application is unavailable. The system and method allows virtual applications to be deployed more broadly by providing a way to handle incompatibilities between the virtual application and application programming interfaces on a target information handling system. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a logical diagram that illustrates the relationship between a virtual application and the other components of an information handling system.

FIG. 2 illustrates a process for creating a virtual application.

FIG. 3 illustrates a process for loading a virtual application as disclosed herein.

FIG. 4 illustrates a process for loading a shared library at runtime that was called by a virtual application as disclosed herein.

FIG. 5 illustrates another process for loading a virtual application as disclosed herein.

FIG. 6 illustrates a process for creating a virtual application as disclosed herein.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

In addition to shared libraries, application software may depend upon the presence of other resources to successfully execute. These resources may include data files, or the presence of configuration settings. For example, it is common for applications designed to run in a Microsoft Windows environment to store application configuration settings in the registry. Frequently, these settings must be present and properly set before the application begins executing, or the application may fail. Software publishers frequently supply an installation program to reduce the difficulty of configuring an information handling system, and its software environment, to support a new application. Some of the tasks that may be performed by an installation program include creating folders or directories, installing a copy of any shared libraries if they are not already installed, setting file access permissions, creating configuration settings in a repository maintained by the operating system (such as the Microsoft Windows registry), setting environment variables, and creating links to the application in the graphical user interface.

Although installation programs make it easier to install and configure a clean copy of an application, installation programs can make it difficult to perform other management tasks. Before installation programs were necessary to deploy an application, an administrator could simply copy a folder containing the already installed application from an existing system to a new system. Furthermore, an administrator could configure the application with organization-specific settings before copying the files, and the settings would remain intact while being copied to the new system. This made it easier to deploy pre-configured applications across an enterprise, or to migrate a user's applications and data to a new system. One solution to these problems is application virtualization. A number of application virtualization solutions are commercially available, such as those offered by Dell Kace. When an application is virtualized, it is contained and encapsulated from the operating system.

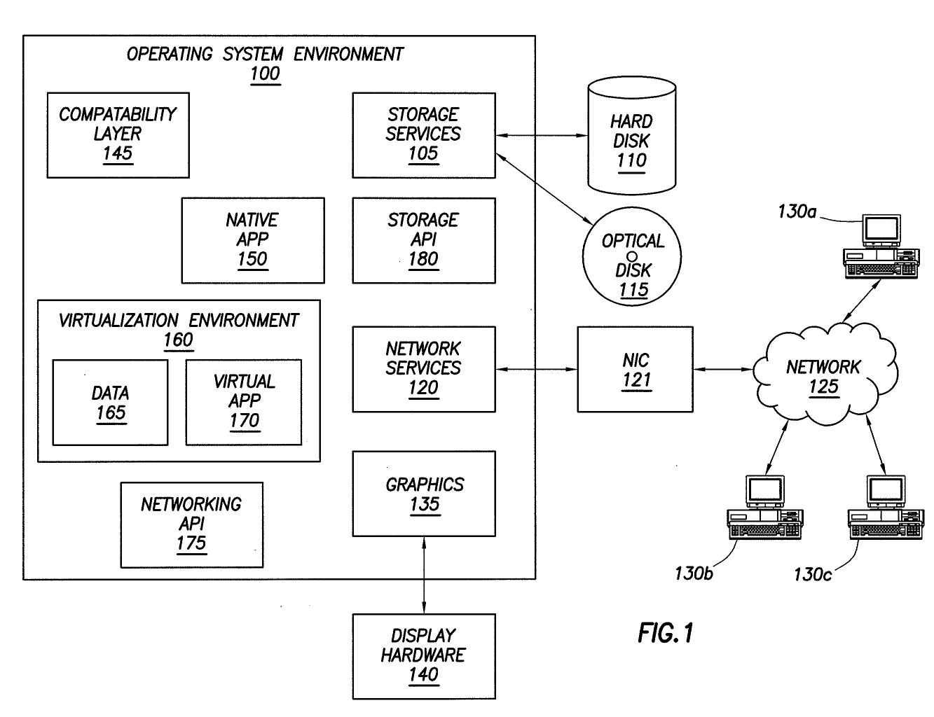

FIG. 1 is a logical diagram depicting the relationship between a virtual application and the other components of an information handling system. The operating system environment 100 depicts the various software entities running within the space managed by the operating system. Storage services 105 controls and manages access to the storage devices of the information handling system, such as a hard disk 110 or an optical disc drive 115. Network services 120 manage networking devices 121, which connect the information handling system to network 125 and networked devices 130a-c. Graphics server 135 is responsible for displaying content on display hardware 140. In addition to the services and servers provided by the operating system, the operating system provides a number of APIs. Storage API 180 provides an interface to storage services 105. Networking API 175 provides an interface to network services 120. The operating system may also contain a compability layer 145. A compability layer 145 may detect calls made by applications to obsolete operating system APIs, and redirect the calls to an available operating system API. Native application 150 runs within its own memory space on the information handling system, and has direct access to the operating system APIs. Virtualization environment 160 hosts a virtual application 170. The virtualization environment 160 functions as a sandbox, and provides the code necessary to intercept calls made by virtual application 170 to other resources on the operating system, and decides what action should be taken. Using the virtualization data 165, the virtualization environment determines whether to allow the call to proceed unaltered, to block the call entirely (such as when it suspects the virtual application 170 can no longer be trusted), or to modify the call by changing the parameters to the API call. For example, if virtual application 170 attempts to copy a file to a file path beginning with “C:\Windows”, the virtualization data 165 may indicate that calls to such paths should be redirected to a space dedicated to the virtual application 170. The virtualization environment 160 may change the parameter that specifies the file path accordingly, and then allow the call to proceed normally.

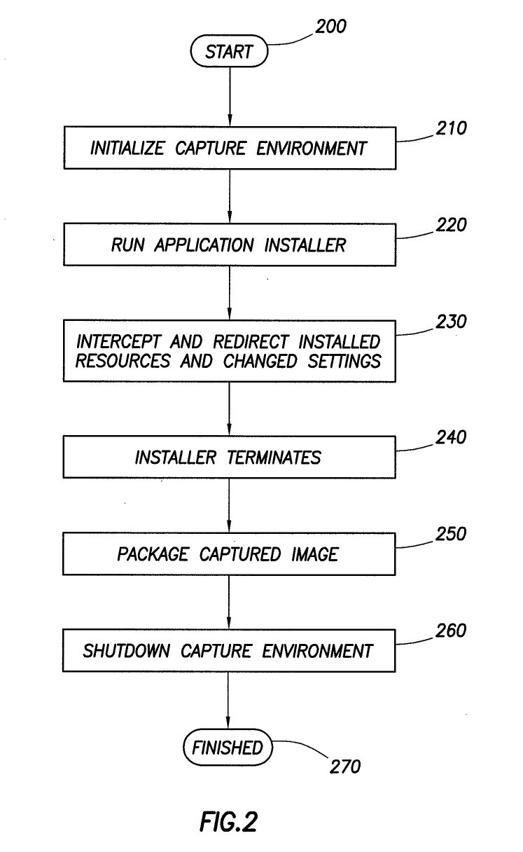

FIG. 2 illustrates a process for creating a virtual application. At step 200, the process is started on an information handling system that is equipped to capture applications. If a capture tool is not installed on the information handling system, it must be installed prior to starting the process. The information handling system chosen should be capable of running the application properly, but the application should not already be installed. For example, if the user wants to virtualize a copy of Microsoft Internet Explorer 6.0, the information handling system selected may be configured with a copy of the Microsoft Windows XP operating system that does not already have Internet Explorer 6.0 installed. At step 110, the capture tool initializes a capture environment. The capture environment functions as a sandbox for running the installer, and provides the code necessary to monitor the installer's activity and any attempts to modify the system. The capture tool may start a process and modify the executable image of the process so that selected operating system calls, such as those that handle file requests, are first processed by the capture tool. Remote thread injection is another way the capture tool may intercept selected activity within the capture environment. After the capture tool configures the capture environment, at step 220 the application installer begins executing inside the capture environment. In this example, the installer for Internet Explorer 6.0 executes. At step 230, the installer runs without being aware of the presence of the capture environment. As the installer performs selected actions, the capture tool intercepts the actions and takes appropriate action. When the installer attempts to copy a file to the file system, the capture tool may redirect the file to a repository where captured items are stored. This repository may be to a hierarchy of folders stored in the file system, a data file, a database (such as SQLite), or the repository may use a combination of approaches for storing data. When settings to a configuration database, such as the registry, are attempted, the capture tool may intercept the new or changed settings and similarly store the settings in the repository. At step 240, the installer finishes executing. At step 250, the capture tool finalizes the capture. This may include cleaning up the data placed in the repository and processing the file so that it can serve as the source for virtualization data 165 for the virtualization environment 160. The capture tool may create a deployment package that contains a code for the virtualization environment, an image of the captured application known as the virtual application image, and the repository. The deployment package may be in the form of an executable file. Alternatively, the capture tool may create a deployment package that only contains an image of the captured application and the repository. This package likely would not be in an executable file format. At step 260, the capture environment stops executing, and the application image has been captured.

Once captured, the virtual application can be easily distributed to any number of information handling systems. If the virtual application image is within an executable deployment package, then the executable deployment package may simply be copied to any number of information handling systems and opened by the user like any other application. If the deployment package does not include the code for the virtualization environment, then the virtualization environment must be installed prior to executing the virtual application.

Virtual applications, like their native counterparts, may depend on shared libraries that were distributed with the original version of the application, distributed with other supporting application software (such as database software), or distributed with the operating system. Just as a native application may fail to execute properly when a shared library is missing, a virtual application can similarly fail. These failures can occur at load time or runtime. At load time, the operating system's loader may fail to load an application if it is unable to find a shared library identified in the import table, if an entry point declared by the application does not exist in the version of the shared library available on the system, or if the address of an entry point declared by the application is forwarded by the shared library to a different shared library that do not exist on the system. Even if the loader allows the application to begin executing despite being unable to locate all of the necessary entry points, then the application will fail during runtime when it attempts to make a jump to an incorrect entry point. If the application uses a shared library with delayed loading or dynamic linking, then these failures may not occur at load time, but will occur whenever the application first attempts to load the shared library at runtime.

There are several ways that these failures may be prevented. First, the compatibility layer of the operating system may include code that detects a mismatch between the shared library needed by the application and the shared library available on the system. The compatibility layer may be able to adjust the entry points in the memory-resident copy of the application's import table to point to the correct entry points for using the available shared library. Another option is to include a copy of a desired shared library with the virtual application.

The desired shared library may be a copy of the library used on the information handling system where the virtual application was captured. During the capture process, the capture tool may be set to capture one or more shared libraries called by the application, and include a copy of the captured shared libraries in the repository of virtualization data, or elsewhere in the deployment package. When the virtual application is deployed, a copy of the captured shared library is available if a suitable version is not already available on the information handling system. If the need for including a shared library in the package was not discovered until after the virtual application image was captured, the capture tool may provide a way for including the desired shared library without capturing the application again. For example, the capture tool may be able to read the deployment package, and based upon an input received from the user, include a copy of a specified shared library in the deployment package. In other instances, capturing a copy of a shared library may not be sufficient. Changes to the operating system or other software on the target information handling system may not be compatible with the shared library. In that instance, a new implementation of the shared library may be created and included in the deployment package.

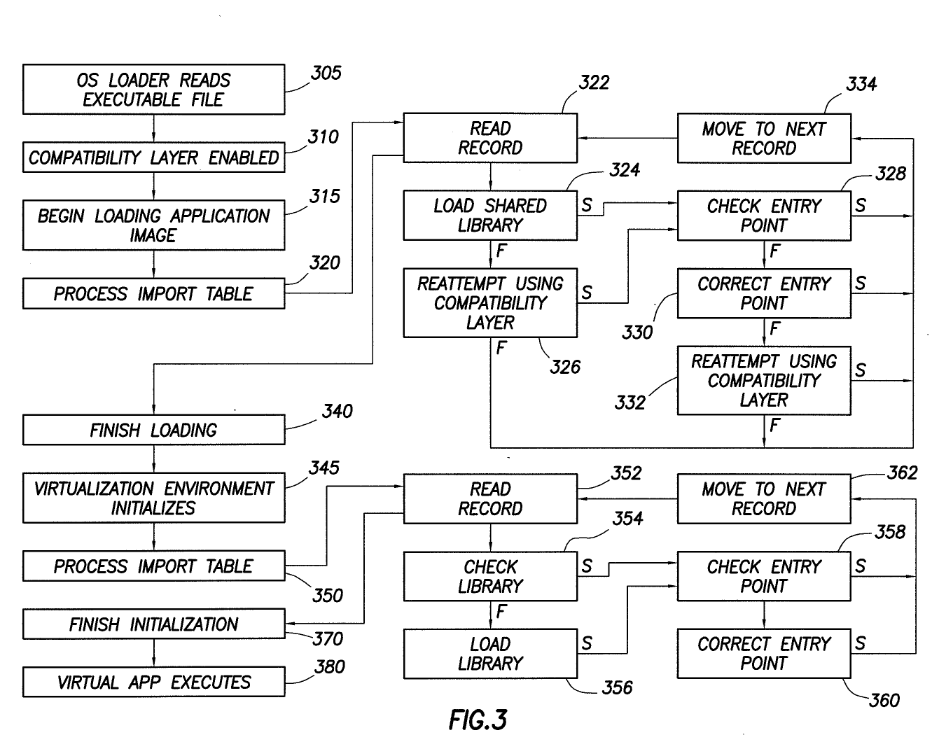

At load time, code that is part of the virtual environment may detect that the required shared library is not available, and will load and link the captured copy of the shared library from the deployment package. FIG. 3 illustrates a process for loading a virtual application as disclosed herein. At step 305, the virtual application is selected for execution on a information system. The executable deployment package is coded or flagged such that the target information handling system enables its compatibility layer. At step 310, the operating system loader notices the coding or flag, and enables the compatibility layer. At step 315, the operating system loader will proceed to load the virtual application image into the information handling system's memory.

At step 320, the loader begins processing the records of the memory-resident import table for the virtual application. At step 322, the first record is read. At step 324, the loader determines whether the identified shared library has been loaded into memory. If the loader is able to locate the identified shared library, it will load the shared library and then proceed to check the corresponding entry point for the function to be called at step 328.

However, if the loader fails to locate the shared library, or is otherwise unable to load the shared library, the loader will invoke the compatibility layer at step 326. The compatibility layer may use mapping information to identify a suitable shared library that is available on the target information handling system. If such a shared library exists, the compatibility layer will load the library, or provide the necessary information to the loader to perform the task. If successful, the loader proceeds to check the entry point at step 328. If the compatibility layer is unable to load a suitable shared library, then the loader will skip over the record, and continue processing the rest of the import table at step 334.

At step 328, the loader attempts to check the entry point for the function to be called within the shared library. The loader may compare the existing entry point address listed in the table against the entry points listed in the shared library's export table. If the entry point is valid, then at step 334 the loader proceeds to check the next record. However, if the entry is not correct, the loader will attempt to correct the issue at step 330. The loader may attempt to lookup the entry point for the function by searching the shared library's export table for an entry point with the same symbolic name for the function. If this is successful, the entry point is updated in the import table, and at step 334, the loader begins processing the next record in the table. However, if the loader fails to find a valid entry point for the function, the loader may consult the compatibility layer at step 332. The compatibility layer may use mapping information to identify a substitute entry point, and update the import table accordingly. If successful, the loader resumes processing the import table at step 334. If the compatibility layer fails, it may skip over the record and continue processing the remaining records at step 334. If there are no more records to be processed at step 332, then the loader proceeds to finish the loading process at step 340.

At step 345, the loader passes control to the code for the virtualization environment. At step 350, the virtualization environment begins processing the import table. At step 352, the first record is read from the import table. At step 354, the virtualization environment confirms that the correct shared library has been loaded. If a library has not been loaded, or the operating system loaded a shared library that the virtualization data indicates is not correct, the virtualization environment will load the correct shared library at step 356. After confirming the correct shared library has been loaded, at step 358 the virtualization environment confirms that the entry point listed in the record is correct. If the entry point is correct, then the virtualization environment continues to step 362 and moves to the next record. If the entry is not correct, then the entry point is corrected using the virtualization data at step 360. Once all of the entries have been checked, the virtualization environment finishes initializing at step 370, and at step 380 the virtual application begins executing.

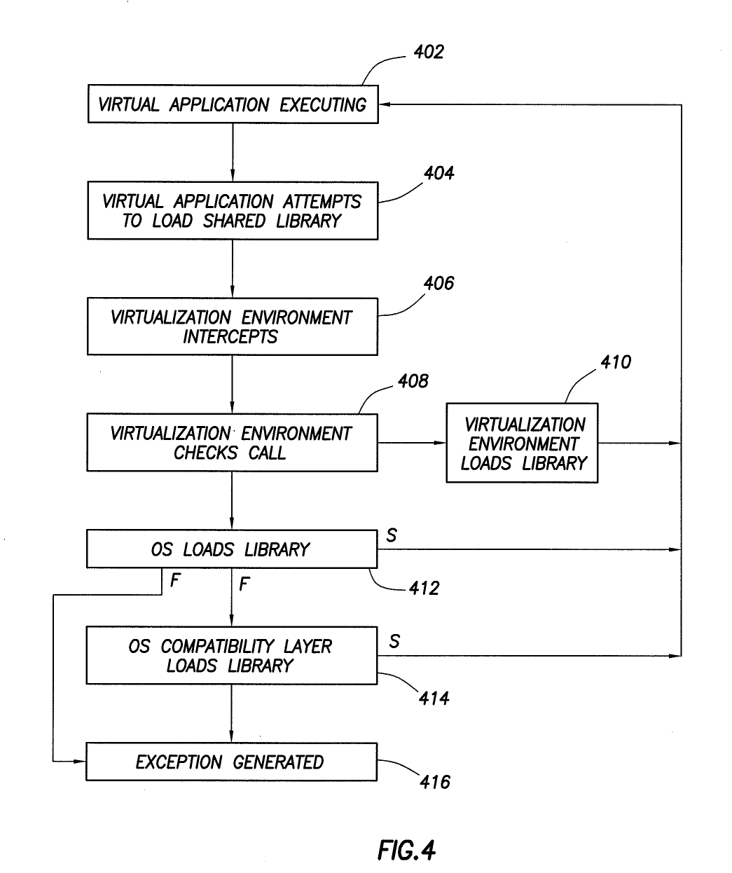

FIG. 4 illustrates a process for loading a shared library at runtime that was called by a virtual application as disclosed herein. At step 402, the virtual application executes normally. At step 404, the virtual application attempts to load a shared library. At step 406, the virtualization environment intercepts the attempt. At step 408, the virtualization environment examines the call, and uses the virtualization data to determine whether the virtualization environment should load the shared library, or allow the call to go through to the operating system. For example, the virtualization environment can check the name of the shared library against a table that lists all of the shared libraries that are available to be loaded from the virtualization data. If there is a match, at step 410 the virtualization environment loads the shared library according to the information in the virtualization data. The virtualization environment supplies the correct entry point and updates the memory-resident import table for the virtual application. The virtual application then resumes executing at step 402.

If the virtualization environment is not responsible for the shared library that the virtual application is attempting to load, then at step 412 the operating system loader receives the call. If the loader is able to successfully load the shared library, the loader will calculate the correct entry point, update the import table, and the virtual application will resume executing at step 402. If the operating system loader is unable to load the shared library or identify the correct entry point, then an exception may be generated at step 416. If the compatibility layer is enabled, the call may be passed on to the operating system's compatibility layer. At step 414, the compatibility layer attempts to load the shared library and set the entry point in the import table. If it succeeds, the virtual application resumes executing at step 402. If all attempts to load the shared library, or set the correct entry point fails, then at step 416 an exception may be generated.

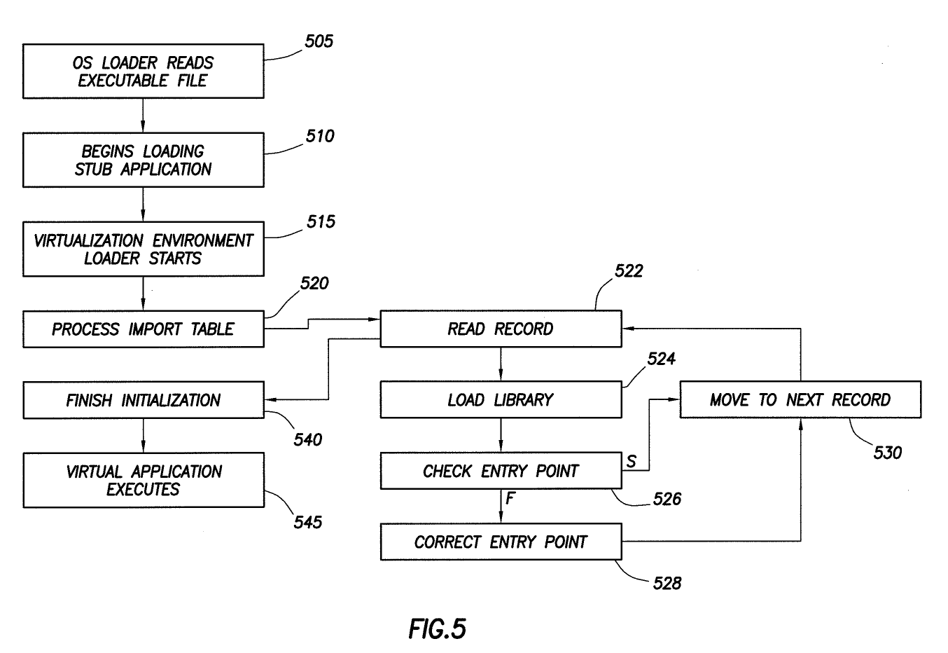

FIG. 5 illustrates another process for loading a virtual application as disclosed herein. At step 505, the operating system loader reads the executable deployment package containing the virtual application, the virtualization data, and a loader for the virtual application. The executable file has been formatted so that the operating system loader only sees a simple stub application that does not import any libraries. At step 510, the stub application is loaded. At step 515, the stub application begins executing code for the virtualization environment and the loader for the virtual application. The loader for the virtual application will load the virtual application image into memory.

At step 520, the virtualization environment uses the loader for the virtual application to begin processing the import table for the virtual application. At step 522, the loader reads a record from the import table. At step 524, the loader loads and links the shared library if it has not already been loaded. At step 526, the loader checks the entry point in the record. If the entry point is correct, the loader moves on to the next record at step 530. If the entry point is not correct, at step 528 the loader may lookup the correct entry point from the virtualization data, or using the export table included in the shared library. The loader then resumes processing the other records at step 530. Once there are no more records to be processed, the loader finishes the loading process, and the virtualization environment finishes initializing at step 540. At step 545, the virtual application begins executing within the virtualization environment.

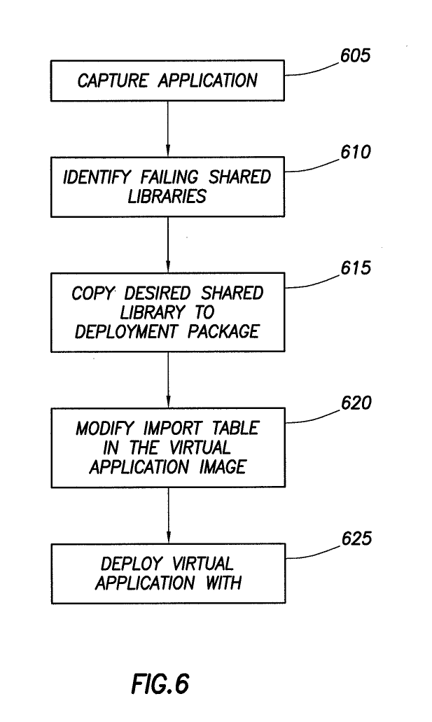

FIG. 6 illustrates a process for creating a virtual application as disclosed herein. At step 605, an application is captured to create a virtual application. The virtual application image may be placed inside a executable deployment package. The deployment package may also contain a code for the virtualization environment, and a structure storing the virtualization data. At step 610, the virtual application image is analyzed to identify any dependencies on a shared library. Each required shared library is analyzed to determine whether a copy of the shared library should be included within the deployment package. This may be accomplished by providing a user interface that allows a user, such as a system administrator, to select which shared libraries should be included in the deployment package. A tool may be provided to check the availability of each shared library on a typical target information handling system. The capture tool may analyze these results and include a copy of each shared library that could not be found on the typical target information handling system. The captured virtual application may be tested on a number of information handling systems. The test results may indicate which shared libraries produce errors, and the capture tool may include a copy of each error causing shared library. Once the shared libraries that should be included with the deployment package are identified, the capture tool captures the appropriate shared library and includes it within the deployment package at step 615. At step 620, the capture tool modifies the import table within the virtual application image to point to the correct shared libraries and the correct entry points. At step 625, the virtual application can be deployed to a target information handling system. At load time and runtime, no adjustments to the import tables should be necessary (other than adjusting for the actual assignment of physical memory addresses).

Although the present disclosure has been described in detail, it should be understood that various changes, substitutions, and alterations can be made hereto without departing from the spirit and the scope of the invention as defined by the appended claims.

What is claimed is:

1. A method for operating a virtual application comprising:
loading an image of the virtual application into a memory of an information handling system from a deployment package;
loading a shared library required for executing the virtual application;
saving an address for a memory location corresponding to an entry point for a function in the shared library to an address table for the virtual application; and
determining whether the address for the memory location corresponding to the entry point for the function in the shared library should be adjusted based upon a virtualization data from the deployment package.

2. The method of claim 1, wherein the shared library is loaded by a loader provided by an operating system.

3. The method of claim 2, wherein the shared library is loaded from the deployment package.

4. The method of claim 3, wherein the shared library is loaded at run-time.

5. The method of claim 2, wherein the shared library is loaded based upon information from a compatibility layer of an operating system.

6. The method of claim 1, wherein the shared library is loaded by a loader provided in the deployment package.

7. The method of claim 6, wherein the shared library is loaded from the deployment package.

8. The method of claim 7, wherein the shared library is loaded at run-time.

9. A non-transitory computer-readable storage medium with an executable file stored thereon, wherein the file causes a microprocessor to perform the following steps:
loading an image of a virtual application into a memory of an information handling system from a deployment package;
loading a shared library required for executing the virtual application;
saving an address for a memory location corresponding to an entry point for a function in the shared library to an address table for the virtual application; and
determining whether the address for the memory location corresponding to the entry point for the function in the shared library should be adjusted based upon a virtualization data from the deployment package.

10. The non-transitory computer-readable storage medium of claim 9, wherein the shared library is loaded by a loader provided by an operating system.

11. The non-transitory computer-readable storage medium of claim 10, wherein the shared library is loaded from the deployment package.

12. The non-transitory computer-readable storage medium of claim 11, wherein the shared library is loaded at run-time.

13. The non-transitory computer-readable storage medium of claim 10, wherein the shared library is loaded based upon information from a compatibility layer of an operating system.

14. The non-transitory computer-readable storage medium of claim 9, wherein the shared library is loaded by a loader provided in the deployment package.

15. The non-transitory computer-readable storage medium of claim 14, wherein the shared library is loaded from the deployment package.

16. The non-transitory computer-readable storage medium of claim 15, wherein the shared library is loaded at run-time.

17. A process for creating a virtual application comprising:
creating an image of a virtual application from an application executing on an information handling system;
saving the image of the virtual application to a deployment package;
identifying a shared library required for executing the virtual application;
saving an address for a memory location corresponding to an entry point for a function in the shared library to an address table in the image of the virtual application; and
saving the deployment package formatted in an executable file format to a non-transitory computer-readable storage medium.

18. The process for creating a virtual application of claim 17, comprising:
saving an image of the shared library to the deployment package.

19. The non-transitory computer-readable storage medium of claim 17.

20. The non-transitory computer-readable storage medium of claim 18.
